(19) United States
(12) Patent Application Publication
(10) Pub. No.: US 2025/0190827 A1
(43) Pub. Date: Jun. 12, 2025

(54) SYSTEM AND METHOD FOR FUZZY LOGIC BASED MODEL RISK MANAGEMENT

(71) Applicant: FAIRLY AI INC., Kitchener (CA)

(72) Inventors: David VAN BRUWAENE, Kitchener (CA); Nikola GRADOJEVIC, Kitchener (CA)

(21) Appl. No.: 18/856,466

(22) PCT Filed: Apr. 24, 2023
(86) PCT No.: PCT/CA2023/050551

§ 371 Date: Oct. 11, 2024

Related U.S. Application Data
(60) Provisional application No. 63/333,852, filed on Apr. 22, 2022.

(51) Int. Cl. G06N 7/02

(52) U.S. Cl. CPC G06N 7/02

(57) ABSTRACT

Embodiments herein generally relate to a system and method for model risk management (MRM) of an artificial intelligence (AI) or machine learning (ML) model. In at least one example, the system comprises: an AI validation system (AIVS) comprising validation processing subsystems, which comprise a fuzzy logic controller (FLC) to implement a fuzzy logic MRM program associated with the AI/ML model. Validation devices are communicatively coupled to the validation processing subsystems and FLC. The FLC receives metadata related to risk management inputs and outputs for the fuzzy logic MRM program. The metadata is received, and a rule base is created. The MRM program receives the inputs from the validation devices, pre-processes the inputs, and fuzzifies the pre-processed inputs. Rules in the rule base are executed using the fuzzified inputs to calculate rule consequent values, which are aggregated. An output fuzzy state is assigned, and actions are performed based on the assigning.

### CROSS-REFERENCE TO RELATED APPLICATIONS

The present applicant claims the priority benefit of U.S. Provisional Application 63/333,852, filed on Apr. 22, 2022, the entire contents of which are incorporated herein by reference.

### FIELD OF THE INVENTION

The present disclosure relates to artificial intelligence (AI) and machine learning (ML) model development and model risk management.

### SUMMARY

Aspect 1A: A system for performing model risk management (MRM) of an artificial intelligence or machine learning model comprising: one or more validation processing subsystems comprising a fuzzy logic controller to implement a fuzzy logic MRM program associated with the artificial intelligence or machine learning model, and one or more validation devices associated with one or more validation users communicatively coupled to the one or more validation processing subsystems; a fuzzy logic controller, executing the fuzzy logic model risk management (MRM) program, being configured for: receiving, from the one or more validation devices, metadata related to risk management inputs and a risk management output for the fuzzy logic MRM program; generating a rule base using the received metadata; receiving, from the one or more validation devices, the risk management inputs for the fuzzy logic MRM program; applying one or more pre-processing operations on the risk management inputs; fuzzifying the pre-processed risk management inputs to generate fuzzified risk management inputs; executing one or more rules in the rule base using the fuzzified risk management inputs to calculate rule consequent values of the fuzzy logic MRM program; aggregating the rule consequent values; assigning a risk management output fuzzy state based on the aggregated rule consequent values; and at least one of the fuzzy logic controller or the one or more validation processing subsystems being further configured for: generating one or more output actions based on the assigning.

Aspect 1B: A system for collective model risk management (MRM) for a plurality of artificial intelligence or machine learning models, comprising: one or more validation processing subsystems, wherein the one or more validation processing subsystems comprises one or more fuzzy logic controllers to implement: (i) a fuzzy logic MRM program for each of the plurality of artificial intelligence or machine learning models, and (ii) a collective MRM operation coupled to the fuzzy logic MRM program for each of the plurality of artificial intelligence or machine learning models, wherein each of the fuzzy logic MRM programs corresponding to each of the plurality of artificial intelligence or machine learning models, computes a risk management output which is transmitted as a risk input to the collective MRM operation, and the fuzzy logic controller, executing the collective MRM operation, is configured for: generating a rule base based on metadata related to the output from each of the fuzzy logic MRM programs, executing one or more rules in the rule base using the risk management inputs to calculate one or more fuzzified values related to the overall output of the collective MRM operation, aggregating the calculated one or more fuzzified values related to the overall output, assigning an overall output fuzzy state based on the aggregation, defuzzifying the overall output fuzzy state to produce an overall output value, at least one of the one or more fuzzy logic controllers and the one or more validation processing subsystems being further configured for: generating one or more output actions based on the overall output amount.

Aspect 1C: A system for sequential risk management for a plurality of artificial intelligence or machine learning models, wherein the system comprises: one or more validation processing subsystems, wherein the one or more validation processing subsystems comprises one or more fuzzy logic controllers to implement a fuzzy logic model risk management (MRM) program for each of the plurality of artificial intelligence or machine learning models, wherein the programs include, a first fuzzy logic MRM program corresponding to a first, of the plurality of artificial intelligence or machine learning models, a second fuzzy logic MRM program corresponding to a second of the plurality of artificial intelligence or machine learning models, the wherein the second MRM program is coupled to the first MRM program, and a first model output from the first artificial intelligence or machine learning model is fed as an input to the second artificial intelligence or machine learning model, the one or more fuzzy logic controllers are configured to execute the first fuzzy logic MRM program to: accept a first set of risk management inputs associated with the first artificial intelligence or machine learning model, and produces a first risk management output, the one or more fuzzy logic controllers are further configured to execute the second fuzzy logic MRM program to: accept a second set of risk management inputs comprising: (i) a set of risk management inputs associated with the second artificial intelligence or machine learning model, and (ii) the first risk management output; generate a second risk management output, generate a rule base based on the set of risk management inputs associated with the second artificial intelligence or machine learning model, and the first risk management output, apply one or more rules in the rule base to calculate the second risk management output.

Aspect 1D: A method for performing model risk management (MRM) of an artificial learning or machine learning model comprising: receiving, from one or more validation devices, metadata related to risk management inputs and risk management output; generating a rule base related to the received metadata; receiving, the risk management inputs from the one or more validation devices; applying, one or more pre-processing operations on the received risk management inputs; fuzzifying, the pre-processed risk management inputs to generate fuzzified risk management inputs; executing, one or more rules in the rule base using the fuzzified risk management inputs to calculate rule consequent values; aggregating, the rule consequent values; assigning, a risk management output fuzzy state based on the aggregated rule consequent values; and generating one or more output actions based on the assigning.

Aspect 1E: A method for collective model risk management (MRM) for a plurality of artificial intelligence or machine learning models, comprising: computing, by each of a plurality of fuzzy logic MRM programs corresponding to each of the plurality of artificial intelligence or machine learning models, a risk management output; sending the risk management output to a collective MRM operation as a risk management input; generating, by the collective MRM operation, a rule base using metadata related to the output from each of the fuzzy logic MRM programs; executing, by the collective MRM operation, one or more rules in the rule base using the risk management inputs to calculate one or more fuzzified values related to an overall output of the collective MRM operation; aggregating, by the collective MRM operation, the calculated one or more fuzzified values related to the overall output; assigning, by the collective MRM operation, an overall fuzzy state based on the aggregation; defuzzifying, by the collective MRM operation, the overall output fuzzy state to produce an overall output value; generating, by at least one of a fuzzy logic controller and a validation processing subsystem, one or more output actions based on the overall output amount.

Aspect 1F: A method for sequential risk management for a plurality of artificial intelligence or machine learning models, wherein the method comprises: receiving, by a first fuzzy logic MRM program, a first set of risk management inputs associated with a first artificial intelligence or machine learning model, of the plurality of artificial intelligence or machine learning models, wherein the first fuzzy logic MRM program corresponds to the first artificial intelligence or machine learning model; generating, by the first fuzzy logic MRM program, a first risk management output based on the received first set of risk management inputs; receiving, by a second fuzzy logic MRM program, a second set of risk management inputs comprising: (i) the first risk management output, (ii) a set of risk management inputs associated with a second artificial intelligence or machine learning model, of the plurality of artificial intelligence or machine learning models, wherein the second fuzzy logic MRM program corresponds to the second artificial intelligence or machine learning model, wherein the first MRM program is coupled to the second MRM program, and a first model output from the first artificial intelligence or machine learning model is fed as an input to the second artificial intelligence or machine learning model; generating, by the second fuzzy logic MRM program, a second risk management output based on the received second set of risk management inputs; generating, by the second fuzzy logic MRM program, a rule base using the second set of risk management inputs; and executing, by the second fuzzy logic MRM program, one or more rules in the rule base to calculate the second risk management output.

Aspect 2: The system of any one of Aspects 1A to 1C, or the method of any one of Aspects 1D to 1F, wherein the fuzzy logic controller is initially configured for prompting one or more validation users via the one or more validation devices, to provide metadata.

Aspect 3: The system of any one of Aspects 1A to 1C, or the method of any one of Aspects 1D to 1F, or Aspect 2, wherein each of the risk management inputs has a corresponding plurality of fuzzy states, the metadata related to the risk management inputs and the risk management output comprises parameters related to the risk management inputs and parameters related to the risk management output, the parameters related to the risk management inputs comprising, a name of each of the risk management inputs, a number of the risk management inputs, a number of fuzzy states corresponding to each risk management input, a name of each of the plurality of fuzzy states corresponding to each of the risk management inputs, a range corresponding to each of the risk management inputs, an influence direction corresponding to each of the risk management inputs, and an importance weight corresponding to each of the risk management inputs.

Aspect 4: The system of any one of Aspects 1A to 1C, or the method of any one of Aspects 1D to 1F, or any one of Aspects 2 to 3, wherein generating the rule base comprises the fuzzy logic controller being further configured for: calculating a number of rules based on the number of risk management inputs and the number of the plurality of fuzzy states corresponding to each of the risk management inputs, generating a classification scheme for a space associated with the risk management output, based on the classification scheme, determining a sub-region for each of a plurality of combinations of risk management input fuzzy states, wherein each of the plurality of combinations of risk management input fuzzy states comprises one of the plurality of fuzzy states corresponding to each of the inputs, and based on the determining, populating the rule base with a plurality of rules, wherein each of the plurality of rules corresponds to one of the plurality of combinations of input fuzzy states.

Aspect 5: The system of any one of Aspects 1A to 1C, the method of any one of Aspects 1D to 1F, any one of Aspects 2 to 4, wherein the one or more pre-processing operations comprises a normalization operation.

Aspect 6: The system of any one of Aspects 1A to 1C, the method of any one of Aspects 1D to 1F, any one of Aspects 2 to 5, wherein the calculating of the one or more fuzzified values related to the output is performed using a Mamdani inference system or a Sugeno inference system.

Aspect 7: The system of any one of Aspects 1A to 1C, the method of any one of Aspects 1D to 1F, any one of Aspects 2 to 6, wherein the fuzzy logic controller, executing the fuzzy logic MRM program, is further configured for: receiving metadata related to one or more auxiliary inputs from the one or more validation devices; generating the rule base using the metadata related to the one or more auxiliary inputs; receiving the one or more auxiliary inputs from one or more auxiliary sources; and executing one or more rules in the rule base based on the received one or more auxiliary inputs.

Aspect 8: The system of any one of Aspects 1A to 1C, the method of any one of Aspects 1D to 1F, any one of Aspects 2 to 7, wherein the one or more auxiliary inputs comprise one of: an ethical input; a protected group input; an equity, diversity and inclusion or inclusivity (EDI) input; a legal input; an accounting input; and a geopolitical input.

Aspect 9: The system of any one of Aspects 1A to 1C, the method of any one of Aspects 1D to 1F, any one of Aspects 2 to 8, wherein the one or more auxiliary inputs comprise an ethical input.

Aspect 10: The system of any one of Aspects 1A to 1C, the method of any one of Aspects 1D to 1F, any one of Aspects 2 to 9, wherein the ethical input either dominates or overrides the risk management inputs in the assigning of the risk management output fuzzy state.

Aspect 11: The system of any one of Aspects 1A to 1C, the method of any one of Aspects 1D to 1F, any one of Aspects 2 to 10, further wherein the fuzzy logic controller, executing the fuzzy logic MRM program, is configured for: applying one or more pre-processing operations on the received one or more auxiliary inputs, wherein the one or more pre-processing operations comprise a thresholding operation.

Aspect 12: The system of any one of Aspects 1A to 1C, the method of any one of Aspects 1D to 1F, any one of Aspects 2 to 11, wherein, wherein the one or more output actions comprises transmitting at least one of: a notification or alert to the one or more validation devices; a command to cause the artificial intelligence or machine learning model to go offline, one or more prompts to one or more development devices coupled to the communications subsystem via the network to perform at least one of examining, replacing or rectifying the model, one or more prompts and signals to update at least one of inventory and dashboards, and one or more prompts and signals to at least one: (i) integrated internal subsystem, (ii) compliance subsystem, and (iii) risk management subsystem, communicatively coupled to the fuzzy logic controller.

Aspect 13: The system of any one of Aspects 1A to 1C, the method of any one of Aspects 1D to 1F, any one of Aspects 2 to 12, initially comprising prompting one or more validation users via one or more validation devices to provide metadata.

Aspect 14: The system of any one of Aspects 1A to 1C, the method of any one of Aspects 1D to 1F, any one of Aspects 2 to 13, wherein the risk management inputs are based on at least one of: financial performance measures associated with the artificial intelligence or machine learning model; statistical risk measures associated with the artificial intelligence or machine learning model; relative performance of the artificial intelligence or machine learning model compared to a benchmark model; one or more statistical accuracy measures related to the artificial intelligence or machine learning model; sign accuracy associated with the artificial intelligence or machine learning model; one or more costs associated with the artificial intelligence or machine learning model; economic value associated with the artificial intelligence or machine learning model; and one or more measures of fairness or bias associated with the artificial intelligence or machine learning model.

Aspect 15: The system of any one of Aspects 1A to 1C, the method of any one of Aspects 1D to 1F, any one of Aspects 2 to 14, wherein a first of the fuzzy logic MRM programs receives one or more auxiliary inputs; and the first fuzzy logic MRM program computes the corresponding risk management output based on the received one or more auxiliary inputs.

Aspect 16: The system of any one of Aspects 1A to 1C, the method of any one of Aspects 1D to 1F, any one of Aspects 2 to 15, further wherein the one or more collective auxiliary inputs comprise the collective ethical input; and the collective MRM program performs one or more pre-processing operations on the collective ethical input, wherein the one or more pre-processing operations comprise a thresholding operation.

Aspect 17: The system of any one of Aspects 1A to 1C, the method of any one of Aspects 1D to 1F, any one of Aspects 2 to 16, wherein each of the fuzzy logic MRM programs computes the corresponding risk management output based on one or more received inputs; the fuzzy logic controller performs compliance aggregation using a compliance aggregation function, wherein the compliance aggregation function receives compliance statuses corresponding to the one or more received inputs to each of the fuzzy logic MRM programs, based on the received compliance statuses, the compliance aggregation function produces an overall compliance status.

Aspect 18: The system of any one of Aspects 1A to 1C, the method of any one of Aspects 1D to 1F, any one of Aspects 2 to 17, wherein the compliance aggregation function is one or more: an all-or-nothing compliance function; a majority vote compliance function; a weighted majority compliance function; a maximum compliance function; a minimum compliance function; a mean compliance function; a median compliance function; a proportional compliance function; an upper bound compliance function; and a lower bound compliance function.

Aspect 19: The system of any one of Aspects 1A to 1C, the method of any one of Aspects 1D to 1F, any one of Aspects 2 to 18, wherein the compliance function is implemented as part of the collective MRM operation.

Aspect 20: The system of any one of Aspects 1A to 1C, the method of any one of Aspects 1D to 1F, any one of Aspects 2 to 19, further wherein the one or more collective auxiliary inputs comprise the collective ethical input; the method further comprising applying, by the collective MRM program, one or more pre-processing operations on the collective ethical input, wherein the one or more pre-processing operations comprise a thresholding operation.

Aspect 21: The system of any one of Aspects 1A to 1C, the method of any one of Aspects 1D to 1F, any one of Aspects 2 to 20, further comprising computing, by each of the fuzzy logic MRM programs, the corresponding risk management output based on one or more received inputs; applying compliance aggregation using a compliance aggregation function, wherein the compliance aggregation function receives compliance statuses corresponding to the one or more received inputs to each of the fuzzy logic MRM programs, and based on the received compliance statuses, the compliance aggregation function produces an overall compliance status.

Aspect 22: The system of any one of Aspects 1A to 1C, the method of any one of Aspects 1D to 1F, any one of Aspects 2 to 21, further wherein the second model is coupled to the first model, and the coupling is via a decision switch; the decision switch is turned off by at least one of the one or more fuzzy logic controllers and the one or more validation processing subsystems based on the first risk management output, thereby preventing the first model output from being input to the second model.

Aspect 23: The system of any one of Aspects 1A to 1C, the method of any one of Aspects 1D to 1F, any one of Aspects 2 to 22, wherein one or more actions are performed by at least one of the one or more fuzzy logic controllers and the one or more validation processing subsystems based on the calculated second risk management output.

Aspect 24: The system of any one of Aspects 1A to 1C, the method of any one of Aspects 1D to 1F, any one of Aspects 2 to 23, wherein the ethical input either dominates or overrides the first set of risk management inputs in the production of the first risk management output.

Aspect 25: A system, comprising or consisting essentially of any combination of elements or features disclosed herein.

Aspect 26: A method, comprising any combination of steps, elements or features disclosed herein.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates a system to enable communications and workflow management between a development team and a validation team.

FIG. 2 shows an example embodiment of a development device.

FIG. 3A shows an example embodiment of an artificial intelligence validation system.

FIG. 3B shows an example embodiment of a fuzzy logic controller.

FIG. 4 shows an example embodiment of a fuzzy logic-based model risk management process.

FIG. 5 shows an example embodiment of a process to generate a rule base.

FIG. 6A shows an example embodiment of a system for collective risk management or model risk aggregation.

FIG. 6B shows an example embodiment of a system for compliance status aggregation.

FIG. 7 shows an example embodiment of a process for collective risk management or model risk aggregation.

FIG. 8 shows an example embodiment of a process for sequential model risk management.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Artificial intelligence (AI) is an approach whereby a computer system mimics human cognitive functions such as learning and problem-solving. Machine learning (ML) is a branch of AI and refers to the process of using mathematical models of data to help a computer learn without direct instruction. This enables a computer system to continue learning and improving on its own, based on experience.

Both AI and ML typically use large data sets to “train” models to achieve desired end goals. Processing these large data sets and training these models are typically beyond the capabilities of the human mind. AI and ML-based models may have advantages over the human mind of being faster, more accurate, and consistently rational in arriving at end results.

Model risk management (MRM) is the process of detecting, assessing, monitoring, reporting and mitigating risks associated with models. The goal of MRM is to reduce potential losses an organization may incur due to the use of mathematical models. Model validation is an important and necessary part of MRM within many industries. For example, the Board of Governors of the United States Federal Reserve System or “the Fed” issued Supervision and Regulation Letter 11-7: Guidance on Model Risk Management, published Apr. 4, 2011, retrieved on Mar. 18, 2022 from https://www.federalreserve.gov/supervisionreg/srletters/sr1107.htm, and hereinafter referred to as SR 11-7, provides a framework for MRM which is tried and tested in well-resourced environments. SR 11-7 covers many possible types of risk, including financial risk and reputational risk. While it is more applicable to quantitative finance or “quant” models, the Fed is updating the SR11-7 framework to include AI and ML-based models as well.

While SR 11-7 covers many possible types of risk, it may not be able to cover all potential sources or aspects of model risk, as model risk may arise on a broader scale outside the expectations and assumptions of regulatory standards such as SR 11-7. Examples of possible model flaws which pose model risk comprise:
Non-existence of a mathematical model of a phenomenon of interest, or if one exists, it is computationally overly expensive;
Omitted variable bias, that is, all factors that may affect the model's output have not been included;
Errors-in-variables problem, that is, a model's data may contain measurement errors;
Technical error or sample bias, that is, a model's data may be missing or are recorded inaccurately;
Outliers in model data which distort the model's performance;
Poor goodness of fit, that is, where a model's inputs are empirically or statistically insignificant, although they are theoretically sound;
A model's historical data are unstable e.g., “heteroskedasticity” and “non-stationarity” problems, and/or the data contain structural breaks;
A model is based on incorrect assumptions e.g., about the market environment and probability distributions of variables, and its predictive accuracy is low;
A model is unstable/unprofitable that is, risky in empirical applications due to its complexity and changing market conditions, that is, the model's estimates are overly sensitive;
A model is accurate in-sample that is it is “overtrained”, but inaccurate out-of-sample that is there is “overfitting”;
A model is misused and its good performance is due to luck that is there is “data snooping” or “data mining”;
A model's categorical and continuous variables are combined in an inappropriate way;
A model's inputs are highly dependent e.g. there is multicollinearity;
A model is dynamic in a time-series context, but it is represented in a static manner, that is there is an “autocorrelation” problem;
A model is non-linear, but it is estimated as a linear model that is there is model misspecification;
A model's estimation, calibration and testing codes contain programming errors;
Hardware bugs are affecting the accuracy and/or speed of the financial models;
A model is not optimized correctly and is trapped in local minima/maxima or may generalize poorly;
A model is estimated/trained on too little data and it performs poorly out-of-sample, that is there is underfitting;
A model is estimated/trained on too much data that may be obsolete and irrelevant because they belong to a different market regime, that is the data are uninformative;
A model's variables may have not been normalized (or standardized), which could impede the model's estimation/training;
A model's parameters are estimated unduly in favor of the most recent training data that is there is a recency effect;
The methodology (that is, mathematical or engineering methods) used to estimate the model is inappropriate or incorrect;
A model is affected by or affects other models that is there is a network effect;
A model is obsolete and does not reflect the market reality, that is there is inappropriate life-cycle management; and
A model may contain unintended bias against protected groups.

As can be seen from the above list of examples of model flaws, some of these flaws are flaws which are specific to AI-and ML-based models.

Furthermore, while SR 11-7 guidelines also list collective risk management or model risk aggregation as an explicit regulatory expectation, SR 11-7 does not prescribe a specific method for collective risk management or model risk aggregation.

Fuzzy logic is a method of approximate reasoning that is used to create sophisticated control systems. It is used to represent analog processes on a digital computer. The processes are such that they involve imprecise linguistic terms (e.g., “significant risk” or “low pricing error”). Fuzzy logic can be used to calculate model risk for different types of models. These comprise, for example:
(1) pricing models,
(2) forecasting models,
(3) trading models,
(4) credit scoring models, and
(5) portfolio allocation models.

Many existing systems apply fuzzy logic in a specialized manner, that is, they apply fuzzy logic for portfolio allocation and to handle certain types of model risk. These systems do not describe the use of fuzzy logic for management to handle the broad variety of model risks that may arise, as described above. This is important as it is likely that in the future, model validation and auditing will require a more generalized approach to cover a greater variety of risks that are not covered in prior systems. Fuzzy-logic-based MRM approaches will need to be able to handle risks inherent to AI/ML models.

Additionally, existing systems do not contemplate the application of fuzzy logic to parallel or collective risk management or model risk aggregation, and sequential MRM, as will be discussed below.

A system and method to enable the use of fuzzy logic for MRM with application to AI and ML models is described below. In the system and method described below, as is often the case in AI and ML model development environments, the model development teams are separated from the validation teams.

While the discussion below concerns AI and ML models in the financial world, the system and method which will be demonstrated below can be applied to a broader range of AI and ML models in areas outside of finance, such as engineering, medicine, manufacturing, software and traffic control.

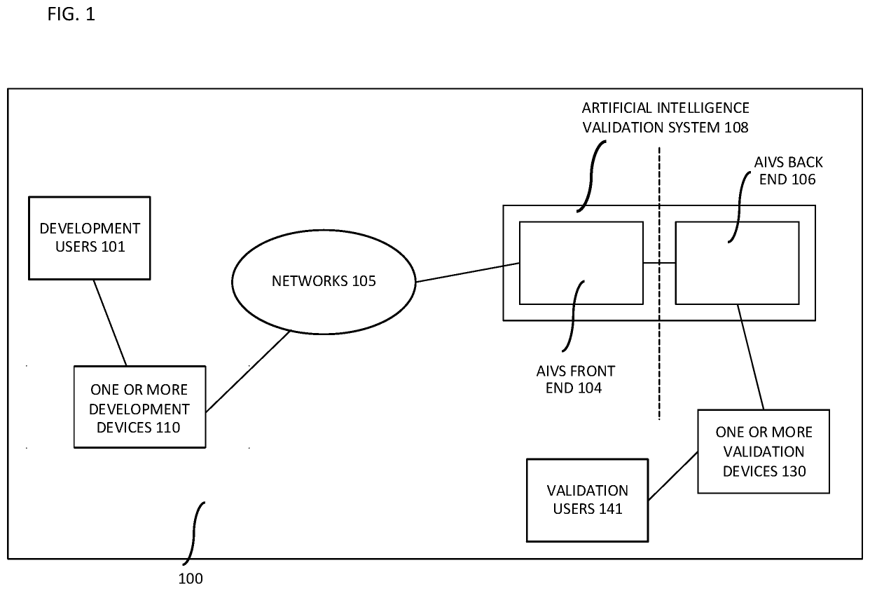

FIG. 1 shows an example embodiment of a system to enable communications and workflow management between a development team and a validation team, as well as to implement fairness, risk evaluation, bias detection, monitoring, mitigation and de-biasing. In FIG. 1, in system 100, one or more development devices 110 are coupled to networks 105.

One or more development devices 110 are associated with development users 101. Development users 101 are, for example, part of a development team. These include, for example, smartphones, tablets, laptops, desktops or any appropriate computing and network-enabled device used for AI or ML model development. In some embodiments, one or more development devices 110 are communicatively coupled to networks 105 so as to transmit communications to, and receive communications from networks 105. One or more development devices 110 is coupled to the other components of system 100 via networks 105.

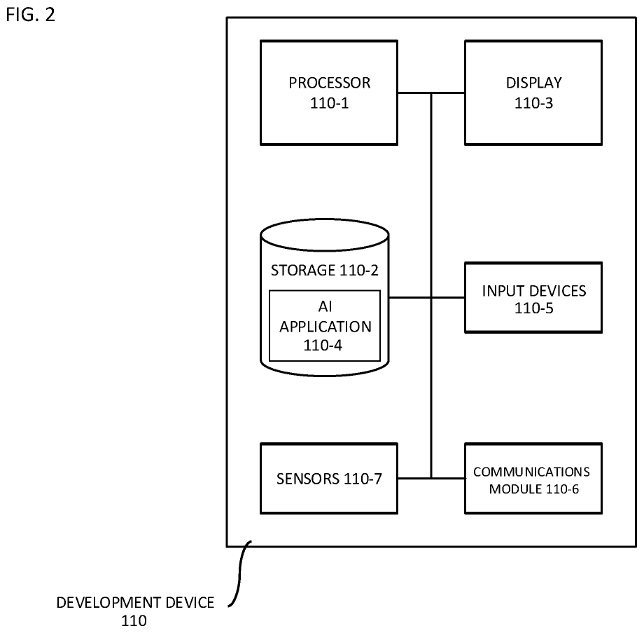

An example embodiment of one of the one or more development devices 110 is shown in FIG. 2. In FIG. 2, processor 110-1 performs processing functions and operations necessary for the operation of one of the one or more development devices 110, using data and programs stored in storage 110-2. An example of such a program is AI/ML application 110-4, which will be described in further detail below. Display 110-3 performs the function of displaying data and information for user 101. Input devices 110-5 allow one of the development users 101 to enter information. This includes, for example, devices such as a touch screen, mouse, keypad, keyboard, microphone, camera, video camera and so on. In some embodiments, display 110-3 is a touchscreen which means it is also part of input devices 110-5. Communications module 110-6 allows user device 110 to communicate with devices and networks external to user device 110. This includes, for example, communications via BLUETOOTH®, Wi-Fi, Near Field Communications (NFC), Radio Frequency Identification (RFID), 3G, Long Term Evolution (LTE), Universal Serial Bus (USB) and other protocols known to those of skill in the art. Sensors 110-7 perform functions to sense or detect environmental or locational parameters. Sensors 110-7 include, for example, accelerometers, gyroscopes, magnetometers, barometers, Global Positioning System (GPS), proximity sensors and ambient light sensors. The components of user device 110 are coupled to each other as shown in FIG. 2.

AI application 110-4 is, for example, where the development users 101 work on various AI-based and ML-based models for financial applications such as the ones described above, to perform activities such as learning or training, testing, and model development. As will be explained below, these AI-based and ML-based models are validated as necessary. In some embodiments, the validation comprises performing MRM.

While the above shows AI application 110-4 stored in storage 110-2, one of skill in the art would recognize that AI application 110-4 can be provided to development device 110 in many ways. In some embodiments, a Software as a Service (SaaS) delivery mechanism is used to deliver AI application 110-4 to the user. For example, in some embodiments the user activates a browser program stored in storage 110-2 and goes to a Uniform Resource Locator (URL) to access AI application 110-4.

In some embodiments, similar to the development devices 110 associated with the development users 110, one or more validation devices 130 are associated with validation users 141. Validation users 141 are, for example, part of a validation team. Examples of validation teams include, for example, teams tasked with performing fair lending analysis, auditing, compliance, governance, risk management and due diligence. As explained above, the development teams are often kept separate from the validation teams. This is implemented using, for example, a firewall or other techniques known to those of skill in the art. Examples of validation devices include, for example, laptops, desktops, servers, smartphones, tablets or any appropriate computing and network-enabled device used for AI model validation. In some embodiments, validation devices 130 have a similar structure to the structure of development device 110 shown in FIG. 2.

Networks 105 plays the role of communicatively coupling the various components of system 100. Networks 105 can be implemented using a variety of networking and communications technologies. In some embodiments, networks 105 are implemented using wired technologies such as Firewire, Universal Serial Bus (USB), Ethernet and optical networks. In some embodiments, networks 105 are implemented using wireless technologies such as WiFi, BLUETOOTH®, NFC, 3G, LTE and 5G. In some embodiments, networks 105 are implemented using satellite communications links. In some embodiments, the communication technologies stated above include, for example, technologies related to a local area network (LAN), a campus area network (CAN) or a metropolitan area network (MAN). In yet other embodiments, networks 105 are implemented using terrestrial communications links. In some embodiments, networks 105 comprise at least one public network. In some embodiments, networks 105 comprise at least one private network. In some embodiments, networks 105 comprise one or more subnetworks. In some of these embodiments, some of the subnetworks are private. In some of these embodiments, some of the subnetworks are public. In some embodiments, communications within networks 105 are encrypted.

In FIG. 1, an artificial intelligence validation system (AIVS) 108 is coupled to network 105. In FIG. 1, AIVS 108 has a front-end 104 and a back-end 106. Front-end 104 is coupled to one or more development devices 110 via network 105. Back end 106 is coupled to front-end 104 as shown above. Back end 106 is also coupled to one or more validation devices 130.

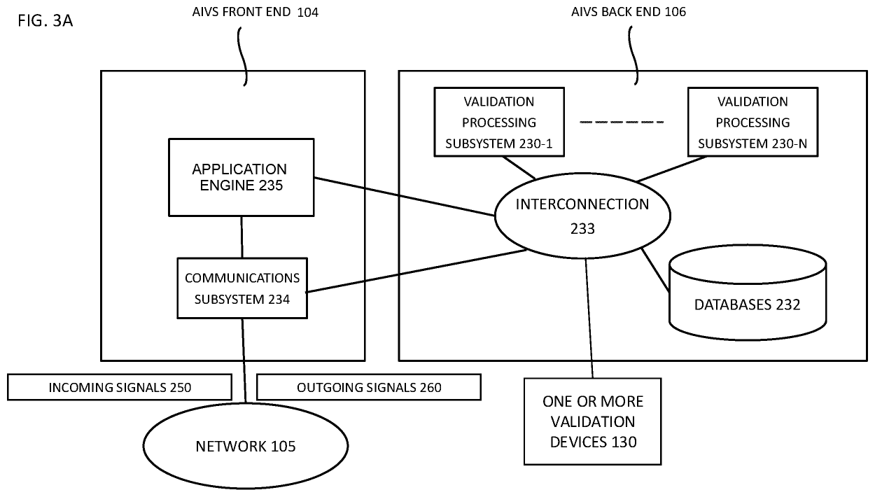

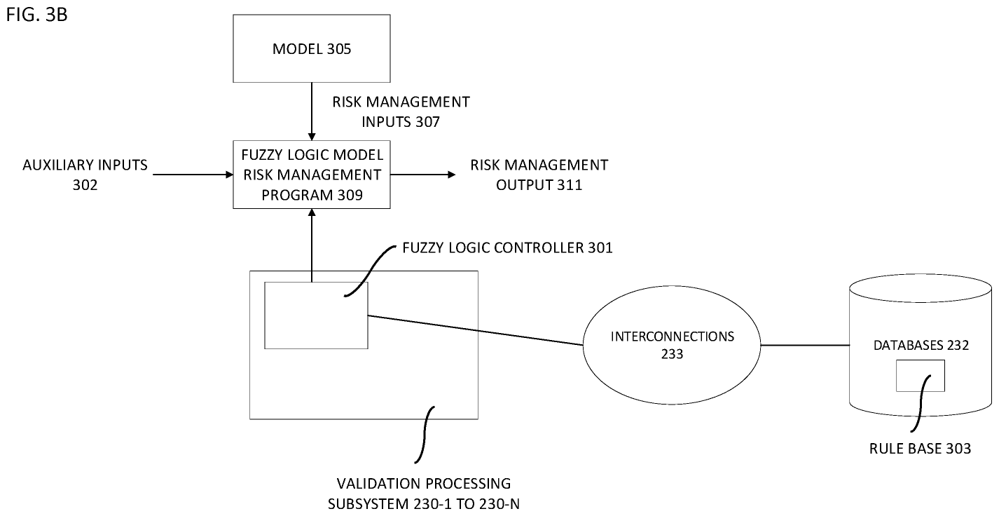

A detailed embodiment of AIVS 108 is shown in FIG. 3A. AIVS 108 performs analysis of AI models for validation purposes. In FIG. 3A, AIVS front-end 104 is comprised of application engine 235 and communications subsystem 234. Communications subsystem 234 is coupled to network 105. Communications subsystem 234 receives information from, and transmits information to network 105. Communications subsystem 234 can communicate using the communications and networking protocols and techniques that network 105 utilizes. Communications subsystem 234 receives information from network 105 within, for example, incoming signals 250; and transmits information to network 105 within, for example, outgoing signals 260.

Application engine 235 is coupled to communications subsystem 234 and the AIVS back-end components via interconnections 233. Application engine 235 is also coupled to network 105 via communications subsystem 234. Application engine 235 facilitates interactions with one or more development devices 110 via network 105 such as opening up application programming interfaces (APIs) with the one or more development devices; and generating and transmitting queries to the one or more development devices 110.

Databases 232 stores information and data for use by AIVS 108. This includes, for example:
one or more algorithms and programs necessary to perform validation, and
other data as needed.

In one embodiment, database 232 further comprises a database server. The database server receives one or more commands from, for example, validation processing subsystem 230-1 to 230-N and communication subsystem 234, and translates these commands into appropriate database language commands to retrieve and store data into databases 232. In one embodiment, database 232 is implemented using one or more database languages known to those of skill in the art, including, for example, Structured Query Language (SQL). In a further embodiment, database 232 stores data for a plurality of sets of development users. Then, there may be a need to keep the set of data related to each set of development users separate from the data relating to the other sets of development users. In some embodiments, databases 232 is partitioned so that data related to each test subject is separate from the other sets of development users. The development users then need to authenticate themselves so as to access information related to their particular data sets. In a further embodiment, when data is entered into databases 232, associated metadata is added so as to make it more easily searchable. In a further embodiment, the associated metadata comprises one or more tags. In yet another embodiment, database 232 presents an interface to enable the entering of search queries. Further details of this are explained below. In some embodiments databases 232 comprises a transactional database. In other embodiments, databases 232 comprise a multitenant database.

Validation processing subsystems 230-1 to 230-N perform processing, analysis and other operations, functions and tasks within AIVS 108 using one or more algorithms and programs; and data residing on AIVS 108. These algorithms and programs and data are stored in, for example:
database 232 as explained above, or
within validation processing subsystems 230-1 to 230-N.

In particular, the validation processing subsystems 230-1 to 230-N are concerned with implementation of AI policies. An AI policy defines the conditions and constraints under which an AI system should operate. An AI policy consists of a sequence of controls which apply to an AI or to an artefact that is relevant to the oversight of an AI system, such as a training dataset, an optimization function or an operational context.

Examples of processing, analysis and other operations performed by validation processing subsystem 230-1 to 230-N comprise:
pre-processing, for example, pre-processing of data sets to remove biases in the data sets, or data drift. In some embodiments, one or more tests are performed to identify data drifts. Examples of such tests include the ones demonstrated in:
   Chow, G. C. (1960), “Tests of Equality between Sets of Coefficients in Two Linear Regressions,” Econometrica, 28, 591-605; and
   Zivot, E., and Andrews, D. W. K. (1992). Further evidence on the great crash, the oil-price shock, and the unit-root hypothesis. Journal of Business & Economic Studies, 10:251-270
risk assessment and detection, including generation of intelligent risk/quality indicators;
auditing operations, including, for example, audit trail generation;
explainability analysis;
bias scanning and detection;
sensitive feature escrow service;
de-biasing, for example,
   remote escrow-data-driven adversarial de-biasing, and
   post-processing to remove detected biases;
upsampling and downsampling;
generation of reports for both validation and development teams, the reports comprising, for example:
   Results from various tests and analyses performed, such as bias and fairness results
   Information associated with the data sets, and
   Model metadata.
management of workflows between validation and development teams;
management of segregation of validation and development teams;
generation of notifications;
sensitivity and stability stress testing of models;
providing editing and editor functionalities;
providing fuzzy logic computation capabilities for MRM; and
providing functionalities relating to generation of chats and comments.
   Which will be explained in further detail below. In some embodiments, validation processing subsystem 230-1 to 230-N implement a risk engine which performs the risk-related tasks outlined above.

In some embodiments, validation processing subsystem 230-1 to 230-N respond to commands provided by validation devices 130 by the validation users. As shown in FIG. 3A, validation devices 130 are coupled to the validation processing subsystem 230-1 to 230-N and databases 232 via, for example interconnection 233. Then, based on the commands provided by validation devices 130, validation processing subsystem perform the processing and analysis explained above.

In some embodiments, validation processing subsystems 230-1 to 230-N comprise a fuzzy logic controller to implement one or more programs for fuzzy logic computations, as explained above. An example embodiment is shown in FIG. 3B, where validation processing subsystems 230-1 to 230-N comprise fuzzy logic controller 301. The operation of fuzzy logic controller 301 will be discussed in further detail below.

In the example shown in FIG. 3B, in some embodiments, fuzzy logic controller 301 implements fuzzy logic MRM program 309 for model 305 using risk management inputs 307. In some embodiments, fuzzy logic controller 301 and validation subsystems 230-1 to 230-N implement fuzzy logic MRM program 309.

The creation of risk management inputs 307 is based on model 305. Then, the fuzzy logic MRM program 309 produces risk management output 311 based on risk management inputs 307, using fuzzy logic.

As previously mentioned, an AI policy consists of a sequence of controls which apply to an AI or to an artefact relevant to the oversight of an AI system. In some embodiments, one or more of risk management inputs 307 are related to the controls of an AI policy.

In particular, the fuzzy logic MRM program 309 utilizes inference rules from a rule base built using expert data to produce risk management output 311, as will be explained below. An example embodiment of a rule base is shown in FIG. 3B, where the fuzzy logic controller 301 has an associated rule base 303. The rule base 303 is stored in, for example, one or more of fuzzy logic controller 301 and databases 232. In the embodiment shown in FIG. 3B, the rule base 303 is stored in databases 232, which is coupled to fuzzy logic controller 301 via interconnections 233.

Examples of risk management inputs 307 which are created based on model 305 comprise:
The model's economic value or profitability;
One or more costs associated with the model, for example, transaction costs, data or software costs;
The model's sign accuracy—this refers to the percentage of correctly predicted directional changes of the model's output values;
The model's statistical accuracy measures, for example, mean-squared prediction error, and mean-absolute prediction error;
The model's relative performance with respect to the statistical significance of the model's improvements against “benchmark models”;
Financial performance measures, for example, the Sharpe ratio, the Sortino ratio, the Treynor ratio, and the Calmar ratio;
Statistical risk measures, for example, standard deviation, skewness, kurtosis, maximum drawdown; and
Measures of fairness and bias of historical data sets used to train the model.

It would be known to one of skill in the art that the risk management inputs to the fuzzy logic controller are either qualitative or quantitative, since a fuzzy logic controller allows both kinds of inputs by using linguistic terms and their corresponding fuzzy membership functions. This is a further advantage of fuzzy logic systems, as fuzzy logic systems allow for more flexibility in the nature of the inputs.

The wide variety and nature of risk management inputs shown above represents a significant departure from the previous works of prior art. In the previous works of prior art, fuzzy logic was used as part of, for example, model 305 to attain certain goals or outcomes. Then, the inputs to model 305 were then used in fuzzy logic computations to produce outputs so as to attain these goals or outcomes. The goals or outcomes could have risk management as one of their objectives.

By contrast, in FIG. 3B, fuzzy logic MRM program 309 manages risk for model 305. The risk management inputs 307 to program 309 are wider ranging. These risk management inputs can be based on inputs to model 305, parameters of model 305, outputs from model 305, and could even include statistical risk measures from model 305. By using a broad range of risk management inputs, this enables more generalized models to be built compared to the prior art on fuzzy logic-based risk management. Then, risk management output 311 offers better understanding of model risk and captures more of the previously mentioned examples of possible model flaws, compared to the previous works of prior art.

In some embodiments, in addition to risk management inputs 307, there are one or more auxiliary inputs 302 to fuzzy logic MRM program 309. Auxiliary inputs 302 are inputs which are independent of the model 305, and which influence risk management output 311. Examples of auxiliary inputs 302 are:
Ethical inputs, that is, inputs related to a major ethical risk episode such as crashes, scandals, and criminal activity;
Protected group inputs, that is, inputs related to unintended biases against protected groups;
Equity, diversity, and inclusion or inclusivity (EDI) inputs, that is, inputs related to EDI considerations;
Legal inputs, that is, inputs related to legal concerns;
Accounting inputs, that is, inputs related to accounting concerns arising from Financial Accounting Standards Board (FASB), Generally Accepted Accounting Principles (GAAP), International Financial Reporting Standards (IFRS) communications and changes;
Geopolitical inputs, that is, inputs related to geopolitical events which have occurred, are occurring or are predicted to occur.

Fuzzy logic controller 301 may be implemented in a variety of ways. In some embodiments, fuzzy logic controller 301 is implemented in a multithreaded manner. In other embodiments, fuzzy logic controller 301 is implemented using a multiprocessor architecture. In yet other embodiments, fuzzy logic controller 301 is implemented using hardware. In yet other embodiments, fuzzy logic controller 301 is implemented using software. In yet other embodiments, fuzzy logic controller 301 implements fuzzy logic MRM programs for a plurality of models. In some of these embodiments, fuzzy logic controller 301 implements fuzzy logic MRM programs for each model within a plurality of models in parallel. In yet other embodiments, fuzzy logic controller 301 works with one or more validation processing subsystems 230-1 to 230-N to perform its functions.

Furthermore, while FIG. 3B shows one fuzzy logic controller 301 implementing a fuzzy logic MRM 309 for one model 305, it would be known to one of skill in the art that a plurality of fuzzy logic controllers, each implementing one or more fuzzy logic MRM programs for a plurality of models can be implemented within validation processing subsystems 230-1 to 230-N.

In yet other embodiments, validation processing subsystems 230-1 to 230-N are implemented using, for example, multitenant implementations known to those of skill in the art. This enables multiple teams to share the resources of validation processing subsystems 230-1 to 230-N.

In some embodiments, some portion of at least one of the operations and functions described above are performed by application engine 235. In yet other embodiments, some portion of at least one of the operations and functions described above are performed by AI application 110-4.

Interconnection 233 connects the various components of AIVS 108 to each other. In one embodiment, interconnection 233 is implemented using, for example, network technologies known to those in the art. These include, for example, wireless networks, wired networks, Ethernet networks, local area networks, metropolitan area networks and optical networks. In one embodiment, interconnection 233 comprises one or more subnetworks. In another embodiment, interconnection 233 comprises other technologies to connect multiple components to each other including, for example, buses, coaxial cables, USB connections and so on.

Various implementations are possible for AIVS 108 and its components. In one embodiment, AIVS 108 is implemented using a cloud-based approach. In some of these embodiments where AIVS 108 is implemented using a cloud-based approach, Kubernetes-based approaches are used. An example of a Kubernetes-based approach is an approach which uses GOOGLE® Kubernetes Engine. In another embodiment, AIVS 108 is implemented across one or more facilities, where each of the components are located in different facilities and interconnection 233 is then a network-based connection. In a further embodiment, AIVS 108 is implemented within a single server or computer. In yet another embodiment, AIVS 108 is implemented in software. In another embodiment, AIVS 108 is implemented using a combination of software and hardware.

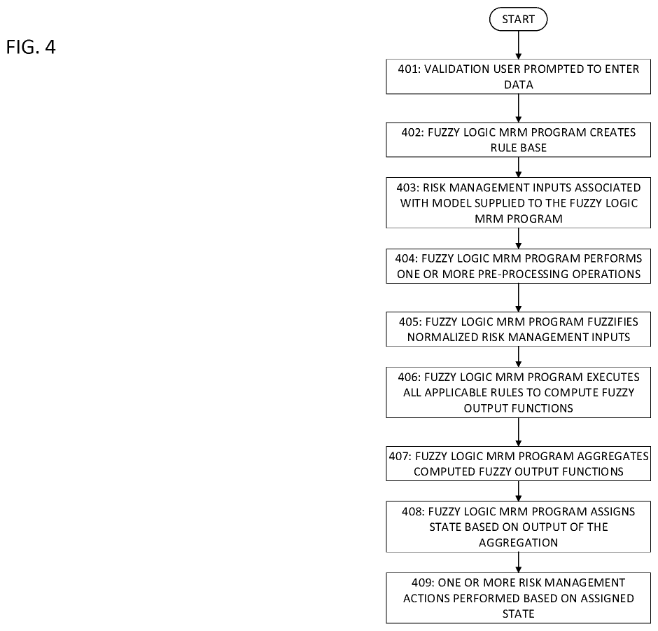

Example processes for fuzzy logic-based MRM for an AI-based or ML-based financial model are shown in FIGS. 4-8, and are explained below with reference to FIGS. 1, 2, 3A and 3B.

FIG. 4 shows an example embodiment of a fuzzy logic-based MRM process carried out by fuzzy logic MRM program 309. As mentioned previously, fuzzy logic MRM program 309 is implemented by fuzzy logic controller 301 either on its own, or together with validation processing subsystem 230-1 to 230-N. In step 401, at least one of validation users 141 is prompted by the fuzzy logic MRM program 309 of FIG. 3B to enter data or metadata for this program to perform risk management operation on an AI-based or ML-based financial model such as model 305 of FIG. 3B. The AI-based or ML-based financial model 305 is, for example, generated using AI application 110-4 running on the one or more development devices 110. In some embodiments, the prompting occurs via the one or more validation devices 130, based on at least one of
receiving of quantitative and qualitative information related to the AI-based or ML-based model 305 by at least one of one or more validation processing subsystems 230-1 to 230-N and database 232 in AIVS back-end 106, wherein the quantitative and qualitative information originates from the one or more development devices 110; and
processing of the received quantitative and qualitative information related to the AI-based or ML-based model 305 by one or more validation processing subsystems 230-1 to 230-N.

In some embodiments, the receiving occurs as follows: Quantitative and qualitative information is transmitted within, for example, incoming signals 250 to communications subsystem 234 in AIVS front end 104. Then, the AIVS front-end 104 extracts, using at least one of the communications subsystem 234 and the application engine 235, the quantitative and qualitative information within the one or more incoming signals 250. At least one of the communications subsystem 234 and application engine 235 in AIVS front-end 104 then transmits the quantitative and qualitative information to at least one of one or more validation processing subsystems 230-1 to 230-N and database 232 in AIVS back-end 106 via, for example, interconnections 233.

In some embodiments, the prompting occurs via a fuzzy logic user interface generated by fuzzy logic MRM program 309 and presented on a display of the one or more validation devices 130. The fuzzy logic user interface comprises, for example, prompts or fields to allow validation users 141 to provide metadata related to risk management inputs such as risk management inputs 307 in FIG. 3B. In some embodiments, the metadata comprises parameters associated with the risk management inputs. The fuzzy logic user interface also comprises, for example, prompts or fields to allow validation users 141 to provide metadata related to risk management output 311, comprising, for example, parameters associated with risk management output 311.

Examples of parameters associated with the risk management inputs 307 comprise:
Name of each risk management input;
Number of risk management inputs to the fuzzy logic MRM program 309 (NI): In some embodiments, the user interface requests the name of each risk management input, and the number of risk management inputs field in the user interface specifies that the minimum NI is one (1). In other embodiments, there is a maximum NI. The maximum NI is based on one or more factors, such as computational complexity and storage capabilities;
Name of each fuzzy state: Each risk management input is associated with a set of fuzzy regions or fuzzy states called a fuzzy set. Each of these fuzzy states are assigned a name from a set, for example set S comprising the natural language terms {“very low”, “low”, “medium”, “high”, “very high”}. These also correspond to different values that qualitative risk management inputs can take on.
Number of fuzzy states for each risk management input (NS): In some embodiments, the user interface specifies that the minimum NS is three (3). In other embodiments, the user interface has a default setting of five (5);
Risk management input range: This refers to the minimum and maximum value of each risk management input, extracted from historical data for the risk management inputs;
Influence direction (ID): This refers to the direction in which the risk management input should influence the calculation of risk management output values. In some embodiments, ID is represented by a binary indicator, for example, one (1) for positive, and zero (0) for negative. When ID is positive, as indicated by a binary indicator that is ID=1, then the risk management output increases as the risk management input approaches the maximum value of the input range. When ID is negative, as indicated by a binary indicator that is ID=0, then the risk management output decreases as the risk management input approaches the maximum value of the input range; and
Importance weights for each risk management input: The fuzzy logic user interface prompts or provides fields for one of the validation users 141 to enter the relative importance associated with each risk management input. In some embodiments, the importance weight is specified as a percentage, and the sum of the importance weight is constrained to add to 100%. In other embodiments, the importance weight is specified as a decimal between zero and one (1), and the sum of the importance weights is constrained to add up to one (1).
Compliance status for each risk management input: In some embodiments, the risk management input has an associated compliant status. In some embodiments, this compliance status is drawn from a set of [“Compliant”, “Not Compliant”]

In some embodiments, the fuzzy logic user interface constrains a user to enter information which is in accordance with an AI policy. For example, the fuzzy logic user interface indicates to a user, that the user must enter one or more importance weights greater than a pre-set threshold, where the one or more importance weights correspond to one or more risk management inputs.

In some of the embodiments where there are auxiliary inputs 302 as well as risk management inputs 307, then the fuzzy logic user interface provides similar functionalities for the auxiliary inputs 302 as for the risk management inputs 307. In some of these embodiments the fuzzy logic user interface comprises, for example, prompts or fields to allow validation users 141 to provide metadata related to auxiliary inputs such as auxiliary inputs 302 in FIG. 3B, similar to those for the risk management inputs 307. In some embodiments, the metadata comprises parameters associated with the auxiliary inputs, similar to those for the risk management inputs 307.

In the embodiments where auxiliary inputs 302 comprise ethical inputs:
In some of these embodiments, the ethical input dominates all other inputs in the process of determining the risk management output 311. In some embodiments, this capability is provided by having the fuzzy logic MRM 309 constrain the importance weight so that it does not drop below a “floor” or a minimum. The fuzzy logic MRM 309 determines whether one of the auxiliary inputs 302 is an ethical input by, for example, providing a field or prompt to the user to provide this information. When the user indicates that it is an ethical input, then the fuzzy logic MRM 309 informs the user via the user interface that the importance weight for the ethical input cannot drop below a “floor” or minimum.
In some of these embodiments, the ethical input overrides all other inputs in the process of determining the risk management output 311. For example, when the ethical input is greater than zero (0), then regardless of the values of the other inputs, the risk management output 311 produces an output corresponding to the highest risk level. Then the ethical input has a veto capability. This is detailed further below.

Examples of parameters associated with the risk management output 311 comprise, for example, name of the risk management output and number of fuzzy output states N_{C}.

The metadata provided by the at least one validation user via the one or more validation devices 130 as a result of the prompting, is received by the fuzzy logic controller 301 and is stored in, for example database 232.

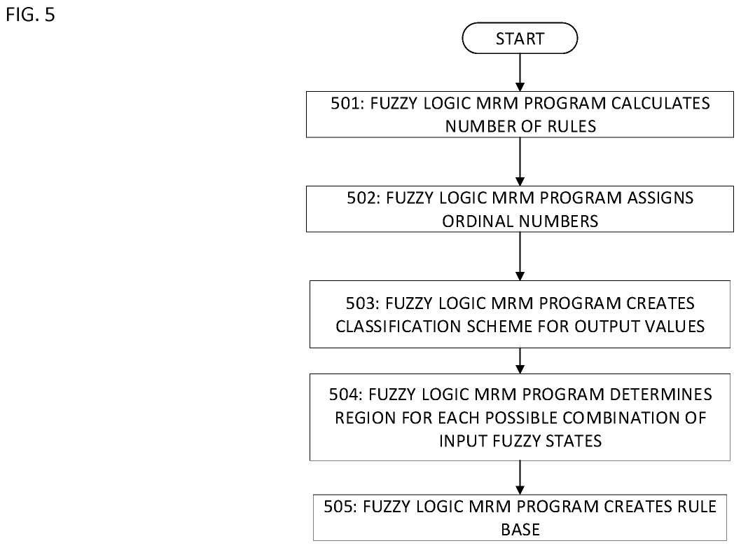

In step 402, based on metadata provided as a result of the prompting, the rule base 303 associated with fuzzy logic MRM program 309 of FIG. 3B is created by the fuzzy logic MRM program 309 based on the metadata provided in step 401. FIG. 5 shows an example embodiment of a process to generate a rule base. In some embodiments, the process demonstrated below is carried out in accordance with an AI policy.

In step 501, the fuzzy logic MRM program 309 calculates the number of rules using mathematical formulas known to those of skill in the art. For example, when all risk management inputs 307 contain the same NS, then the number of rules is given as NSNI. So, when there are 3 risk management inputs (NI=3), each having 5 states (NS=5), then the number of rules is 53=125.

In step 502, the fuzzy logic MRM program 309 assigns ordinal numbers from 1 to NS to each fuzzy state of each risk management input.

In step 503, the fuzzy logic MRM program 309 creates a classification scheme for the risk management output 311 values. In some embodiments, this step comprises decomposing the possible output space for the risk management output 311 into a number N_{C} of fuzzy states associated with the output. Each of these fuzzy states has an associated sub-region. Each of these output fuzzy states has a name drawn from a set comprising natural language terms, for example, {“low”, “medium”, “high”}, corresponding to levels of risk. The division is performed using mathematical formulas known to those of skill in the art. In some embodiments, the regions are equally spaced. An example process is as follows: The region for the risk management output space is [1, NS]. This region is further divided into

$$\frac{( NS - 1 )}{{N}_{C}}$$

sized sub-regions. Hence the boundaries of the N_{C} sub-regions will be

$$[ 1 , 1 + \frac{( NS - 1 )}{{N}_{C}} ] , [ 1 + \frac{( NS - 1 )}{{N}_{C}} , 1 + 2 \times ( \frac{( NS - 1 )}{{N}_{C}} ) ] \text{} … [ 1 + ( {N}_{C} - 1 ) \times ( \frac{( NS - 1 )}{{N}_{C}} ) , NS ] .$$

These sub-regions will be used to determine the output fuzzy state in the consequent of the rules, as will be explained below. In some embodiments, each of these sub-regions or fuzzy output states is associated with a colour. For example, N_{C}=3, and a colour is assigned to each output sub-region. In some embodiments, these colours act as risk level indicators. For example:
red for sub-region corresponding to “high” fuzzy output state or high risk;
amber/orange for sub-region corresponding to “medium” fuzzy output state or medium risk; and
green for sub-region corresponding to “low” fuzzy output state or low risk.

In step 504, the fuzzy logic MRM program 309 determines the output sub-region for each of the possible combinations of risk management input fuzzy states. For this step, the fuzzy logic MRM program 309 creates all possible combinations of input fuzzy states. Each of these combinations comprise one of the NS fuzzy states corresponding to each of the NI risk management inputs. For example, in the case where NI=3 and NS=5, an example combination is [X(1,1); X(2,2) and X(5,3)] where:
X(1,1) is risk management input fuzzy state 1 corresponding to risk management input 1;
X(2,2) is risk management input fuzzy state 2 corresponding to risk management input 2; and
X(5,3) is risk management input fuzzy state 5 corresponding to risk management input 3.

For each combination, the fuzzy logic MRM program 309 calculates an output value Y=W₁×(ordinal number corresponding to risk management input fuzzy state for risk management input 1)+ . . . . W_{NI}×(ordinal number corresponding to risk management input fuzzy state for risk management input NI) for each combination, where W₁, W₂ . . . . W_{NI} are the importance weights corresponding to the NI risk management inputs. Then using the calculated output value Y, the fuzzy logic MRM program 309 determines the sub-region of the risk management output space this falls into, and the corresponding risk management output fuzzy state using the classification scheme developed in step 503.

In step 505, the fuzzy logic MRM program 309 populates rule base 303 with the NSNI rules. Each of the rules corresponds to one possible combination. In some embodiments, each of the NSNI rules is an IF-THEN rule, comprising one or more antecedents or premises and a consequent or conclusion, and employing fuzzy logic operators such as fuzzy “AND” or fuzzy “OR”. An example format for each rule is shown below:

IF<x₁ is A₁> AND <x₂ is A₂> AND . . . THEN <y is B>
where x₁, x₂, . . . and y are scalar variables,
   A₁, A₂, . . . and B are linguistic values corresponding, and
   the fuzzy “AND” operator is used.

The antecedents or premises comprise the phrases “xᵢ is Aᵢ” (i=1, 2, . . . , M), while the consequent or conclusion comprises the phrase “y is B”.

Following this example, in one example embodiment, each of the NSNI rules in the rule base 303 is written as:

IF<X₁ is A₁> AND <X₂ is A>> AND . . . <X_{NI} is A_{NI}>THEN <M is B>
where X₁, X₂, . . . . X_{NI} are the risk management inputs,
   M is the risk management output,
   A₁, A₂, . . . . A_{NI} are linguistic values, each corresponding to a name of one of the
   NS fuzzy states for each of the NI risk management inputs,
   B is a linguistic value corresponding to the name of the risk management output fuzzy state determined in step 504.

One of skill in the art would appreciate that in some of the embodiments where there are auxiliary inputs 302, the operations described above for step 402 are performed for, and take into account the auxiliary inputs as well.

For some of the embodiments where auxiliary inputs 302 comprise an ethical input:
As explained previously, in some embodiments, the ethical input dominates all other inputs by constraining the importance weight for the ethical input to be above a “floor” or minimum.
As also explained previously, in some embodiments, the ethical input overrides all other inputs. This is achieved by, for example, including one or more rules in the rule base 303 to provide this veto or override capability. For example, when the ethical risk is in a “high” state, then the fuzzy output state is “high” or high risk.

Returning to the process of FIG. 4, in step 403, the risk management inputs 307 associated with the model 305 are supplied from the one or more validation devices 130 to the fuzzy logic MRM program 309. As explained previously, one of skill in the art would know that these risk management inputs 307 are either qualitative or quantitative in nature. One of skill in the art would appreciate that in the embodiments where there are auxiliary inputs 302, the auxiliary inputs are supplied from one or more auxiliary sources. Examples of these one or more auxiliary sources include the one or more validation devices, and sources which are different from the one or more validation devices 130. The auxiliary inputs are either qualitative or quantitative in nature.

In step 404, the fuzzy logic MRM program 309 performs one or more pre-processing operations on the risk management input values provided in step 403. In some embodiments, the one or more pre-processing operations comprises the fuzzy logic MRM program 309 normalizing the risk management inputs supplied in step 403 using one or more normalization operations known to those of skill in the art. In some of these embodiments the risk management inputs are normalized to a range, for example, [0,1].

In some embodiments, the one or more normalization operations depends on the ID. When the ID is positive, then the risk management inputs are normalized to a range and the influence of the normalized risk management inputs behaves in the same way as the non-normalized risk management inputs, that is, the influence increases as the normalized risk management input value approaches the maximum value of the range. When the ID is negative, then the risk management inputs are normalized such that the influence of the normalized risk management inputs behaves in the opposite way to the non-normalized risk management inputs, that is, the influence increases as the normalized risk management input value approaches the maximum value of the range. In either case, the normalization operation serves to ensure that the ID of the normalized risk management inputs is positive.

As explained above, in some embodiments, the ID is represented by a binary indicator where one (1) indicates a positive ID, and zero (0) indicates a negative ID. An example of a series of normalization operations based on a binary indicator ID is provided below:
I. When ID=1, then normalize each risk management input on the range [0,1];
II. When ID=0:
   a. When the minimum value of the risk management input (MIN)>0 and the maximum value of the risk management input (MAX)>0: take the inverse value

$$( \frac{1}{each input value} )$$

and normalize the new values on the range [0, 1];
b. When MIN <0 and MAX <0: take the absolute value of each risk management input value and normalize the new values on the range [0, 1];
c. When MIN <0 and MAX >0: add first the MIN (minimum value) to each risk management input value, then take the inverse value of the resulting values and normalize the new values on the range [0, 1].

In some embodiments, step 404 is performed as part of step 403.

One of skill in the art would appreciate that in some of the embodiments where there are auxiliary inputs 302, the operations described above for step 404 are also applied to the auxiliary inputs.

For the embodiments where auxiliary inputs 302 comprise an ethical input: In some of these embodiments the one or more pre-processing operations comprise a thresholding operation. For example, when the ethical input risk value is less than a threshold, then the thresholding operation outputs a zero (0). When the ethical input risk value is more than the threshold, then the thresholding operation outputs a one (1). In some embodiments, the threshold is zero (0). In some embodiments, the threshold is set to a value greater than zero to take into account the possibility of ethical risk measurement errors and noise.

In step 405, based on the normalized risk management inputs from step 404, the fuzzy logic MRM program 309 “fuzzifies” the normalized risk management inputs, that is, the fuzzy logic MRM program 309 converts the normalized risk management input into a fuzzy variable using risk management input fuzzy membership functions. The risk management input fuzzy membership functions are, for example, Gaussian, triangular, trapezoidal, sigmoidal or any suitable membership function known to those of skill in the art. As would be known to one of skill in the art, the fuzzification process results in a degree of membership of each of the risk management input fuzzy states.

As was explained previously, one of skill in the art would know that in some embodiments fuzzy logic inputs are qualitative in nature, that is,

One of skill in the art would appreciate that in some of the embodiments where there are auxiliary inputs 302, the operations described above for step 405 are also applied to the auxiliary inputs.

For some of the embodiments where auxiliary inputs 302 comprise an ethical input: In some of these embodiments, the fuzzy logic MRM program 309 does not convert the pre-processed ethical input into a fuzzy variable. Rather it converts the pre-processed ethical input into one state or another, for example “low risk” or “high risk”.

In step 406, the fuzzy logic MRM program 309 uses the fuzzified risk management inputs to execute all applicable rules in rule base 303, so as to compute consequent output values for all applicable rules. The rule consequent output values are also fuzzified. In some embodiments, this is performed using inference systems such as the Mamdani inference system or the Sugeno inference system.

One of skill in the art would appreciate that in some of the embodiments where there are auxiliary inputs 302, the operations described above for step 406 are also applied to, and take into account, the auxiliary inputs.

For some of the embodiments where auxiliary inputs 302 comprise an ethical input: In some of the embodiments where the ethical input overrides all other inputs, then there is no fuzzification of the rule consequent output values. For example, if the ethical input is “high risk”, then the risk management output state is high.

In step 407, the fuzzy logic MRM program 309 aggregates the rule consequent values computed in step 406 to obtain a risk management fuzzy output set using one or more techniques known to those of skill in the art.

In step 408, the fuzzy logic MRM program 309 then assigns a risk management output fuzzy state based on the risk management fuzzy output set from the aggregation function carried out in step 407.

One of skill in the art would appreciate that in some of the embodiments where there are auxiliary inputs 302, the operations described above for step 407 and 408 also apply to, and take into account, the auxiliary inputs.

For some of the embodiments where auxiliary inputs 302 comprise an ethical input which overrides all other inputs, since in some cases there is no fuzzification, then steps 407 and 408 are not performed.

In step 409, one or more risk management or risk mitigation actions are performed based on the output fuzzy state assigned in either step 408 or one of the preceding steps. For example, if risk is determined to be too high based on the output fuzzy state assigned, the one or more actions performed comprise sending a notification or alert to the validation devices 130. In some embodiments, this comprises sending an alert to prompt the colour corresponding to the assigned output fuzzy state to display on at least one of the validation devices 130. In other embodiments, the one or more actions comprise either sending a command within, for example, outgoing signals 260 to AI application 110-4 to cause the model 305 to go offline. In yet other embodiments, the one or more actions comprise sending one or more prompts within, for example, outgoing signals 260 to AI application 110-4 to perform at least one of examining, replacing or rectifying the model 305. In yet other embodiments, when model 305 is a trading model, the one or more actions comprise sending prompts to cause model 305 within AI application 110-4 to hold current positions and stop trading. In yet other embodiments, the one or more actions comprise sending one or more prompts and signals to, for example, update inventory and update dashboards. In yet other embodiments, the one or more actions comprise sending one or more prompts and signals to integrated internal subsystems and compliance/risk management subsystems. In some embodiments, these one or more risk management or risk mitigation actions are performed by the fuzzy logic MRM program 309. In yet other embodiments, these one or more risk management or risk mitigation actions are performed by at least one of the fuzzy logic controller 301 and the validation processing subsystems 230-1 to 230-N outside of the operation of the fuzzy logic MRM program 309.

The benefit of using a fuzzy logic process stems from the fact the risk management output is represented by natural language terms and also that it is easy to interpret the model based on the degree of activation of, and the number of activated fuzzy rules in the rule base.

One of skill in the art would understand that variations to the above example process are possible. For example, in some embodiments the fuzzy rule base is adjustable and expandable depending on the importance of risk management inputs to the user.

In some embodiments, the fuzzy logic controller 301 also performs collective risk management or parallel risk management or model risk aggregation for a plurality of models. Then, after MRM is performed for each model within the plurality of models, the fuzzy logic controller 301 performs collective MRM operations or model risk aggregation operations.

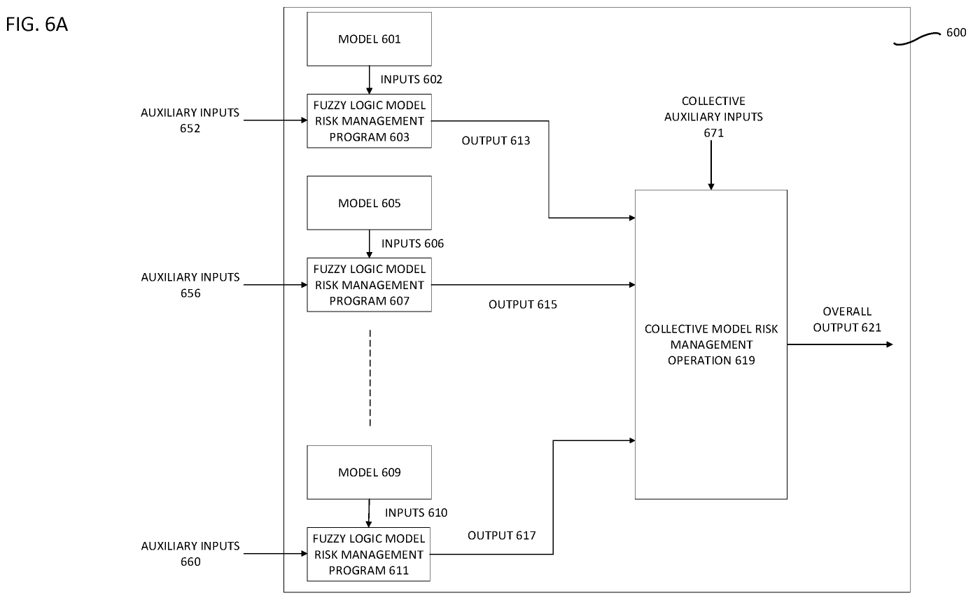

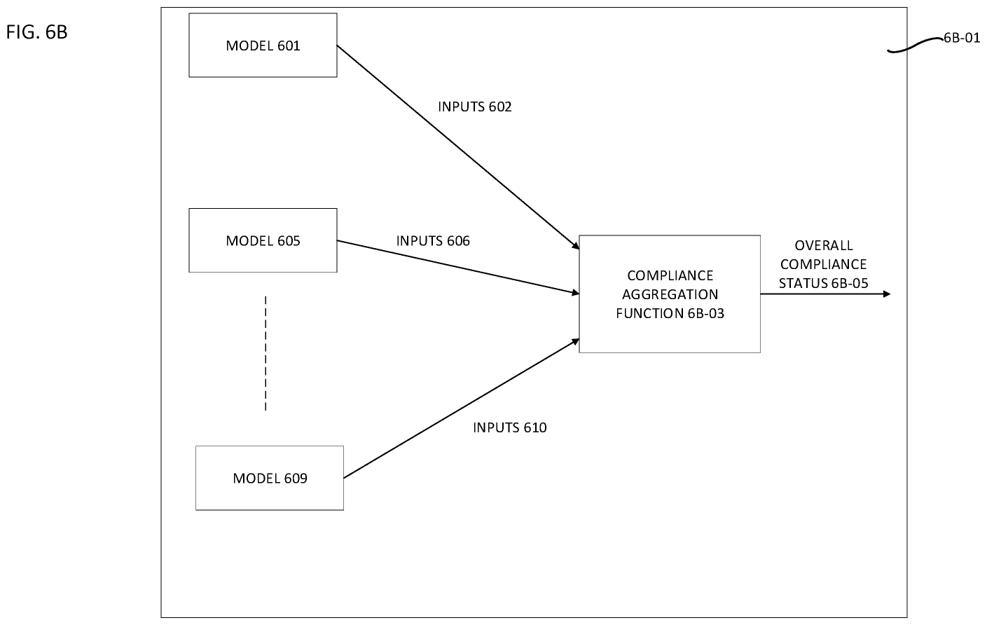

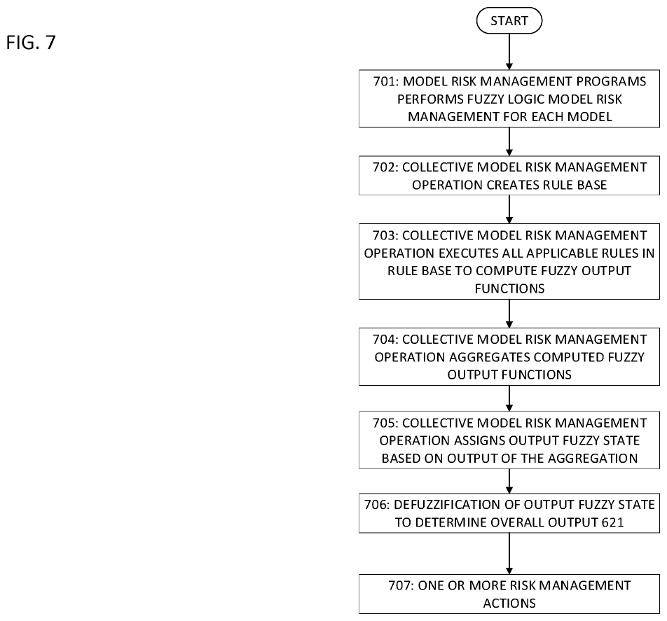

An example embodiment is shown in FIGS. 6-7. In FIG. 6A, a system for collective MRM or model risk aggregation 600 is implemented by one or more fuzzy logic controllers. Then,
fuzzy logic MRM program 603 performs MRM for model 601 using risk management inputs 602 associated with model 601 and auxiliary inputs 652; and produces a risk management output 613. In some embodiments, risk management output 613 is represented as an output fuzzy state;
fuzzy logic MRM program 607 performs MRM for model 605 using risk management inputs 606 associated with model 605 auxiliary inputs 656; and produces a risk management output 615. In some embodiments, risk management output 615 is represented as an output fuzzy state; and
fuzzy logic MRM program 611 performs MRM for model 609 using risk management inputs 610 associated with model 609 and auxiliary inputs 660; and produces a risk management output 617. In some embodiments, output 617 is represented as an output fuzzy state.

Auxiliary inputs 652, 656 and 660 are similar to auxiliary inputs 302 as described above. Then, similar to as described above, in some embodiments, auxiliary inputs 652, 656 and 660 comprise an ethical input. In some of these embodiments, the ethical input dominates the other auxiliary and risk management inputs, as described above. In some of these embodiments, the ethical input overrides the other auxiliary and risk management inputs, as described above.

The one or more validation processing subsystems 230-1 to 230-N comprise one or more fuzzy logic controllers including fuzzy logic controller 301 to implement fuzzy logic MRM programs 603, 607 and 611; and collective MRM operation 619. In some embodiments, fuzzy logic MRM programs 603, 607 and 611; and collective MRM operation 619 are all implemented by fuzzy logic controller 301. In other embodiments, fuzzy logic MRM programs 603, 607 and 611 are implemented by one or more fuzzy logic controllers separate from fuzzy logic controller 301; while collective MRM operation 619 is implemented by fuzzy logic controller 301. In yet other embodiments, each of fuzzy logic MRM programs 603, 607 and 611 are implemented by a separate fuzzy logic controller.

Fuzzy logic MRM programs 603, 607 and 611 are coupled to collective MRM operation or model risk aggregation operation 619. In the embodiments where the one or more fuzzy logic controllers which implement any of fuzzy logic MRM programs 603, 607 and 611 are different from the fuzzy logic controller which implements model risk aggregation operation 619, then the one or more fuzzy logic controllers are communicatively coupled to the fuzzy logic controller which implements model risk aggregation operation 619. This allows for risk management outputs 613, 615 and 617 to be fed as risk management inputs to collective MRM operation 619.

In some embodiments, collective MRM operation 619 also takes collective auxiliary inputs 671 into account to produce overall output value 621. Collective auxiliary inputs 671 are similar to auxiliary inputs 302 as described above. Examples of collective auxiliary inputs include:
Collective ethical inputs, similar to ethical inputs described above;
Collective protected group inputs, similar to protected group inputs described above;
Collective EDI inputs, similar to EDI inputs described above;
Collective legal inputs, similar to legal inputs described above;
Collective accounting inputs, similar to accounting inputs described above; and
Collective geopolitical inputs, similar to geopolitical inputs described above.

In embodiments where collective auxiliary inputs 671 comprise a collective ethical input: In some of these embodiments, the collective ethical input dominates the other auxiliary and risk management inputs in the production of overall output value 621, similar to as described above. In some of these embodiments, the collective ethical input overrides the other auxiliary and risk management inputs in the production of overall output value 621, similar to, as described above.

Overall output value 621 comprises, for example, a monetary amount or an amount of a measure related to a risk, for example, operational, reputational, moral and ethical risk.

An example process to produce overall output 621 is detailed in FIG. 7. In step 701, fuzzy logic MRM is performed in fuzzy logic MRM programs 603, 607 and 611 to produce risk management outputs 613, 615 and 617; each of which have associated output membership values. This is performed by one or more fuzzy logic controllers which implement fuzzy logic MRM programs 603, 607 and 611. In some embodiments, the process used in FIGS. 4 and 5 are used by fuzzy logic MRM programs 603, 607 and 611 to produce the output fuzzy states related to outputs 613, 615 and 617 respectively.

Similar to step 402, in step 702 the fuzzy logic controller 301 implements collective MRM operation 619 to create a rule base based on metadata related to risk management outputs 613, 615 and 617. This metadata comprises similar parameters similar to as described in step 402 such as:
the number of models (NM), which in the embodiment shown in FIG. 6A is three (3).
the number of model risk management input states (NMI): This is equal to the number of possible risk management output fuzzy states for each of the risk management outputs. Using the previous example, there are three possible risk management output fuzzy states from each of fuzzy logic MRM 603, 607 and 611. Then, NMI is three (3);
importance weights of inputs: Each model is assigned a weight either as a percentage from 0 to 100%, or as a decimal between 0 and 1. The sum of all the weights must either be 100% or 1. The weights are determined and entered by the validation user. In some embodiments, the weights are determined and entered based on the organization's strategic goals, that is, certain models are prioritized.
Using a similar process as outlined in FIG. 5, NMINM rules are created by collective MRM operation 619. Using the example above, 33=27 rules are created using a similar process as outlined in FIG. 5.

Similar to as discussed above for step 402, one of skill in the art would appreciate that in some of the embodiments where there are collective auxiliary inputs 671, the operations described above for step 402 are performed for, and take into account the collective auxiliary inputs as well.

For some of the embodiments where collective auxiliary inputs 671 comprise an collective ethical input:
As explained previously, in some embodiments, the collective ethical input dominates all other inputs to collective MRM operation 619 by constraining the importance weight for the collective ethical input to be above a “floor” or minimum.
As also explained previously, in some embodiments, the collective ethical input overrides all other inputs to collective MRM operation 619. This is achieved by, for example, including one or more rules in the rule base for collective MRM operation 619 to provide this veto or override capability. For example, when the collective ethical risk is in a “high” state, then the overall output 621 reflects a “high” or high risk value.

The data range for each of the risk management outputs 613, 615 and 617 which are fed as risk management inputs to the collective MRM operation 619 is normalized, as the outputs from each model are normalized to [0, 1]. The influence direction is positive.

Similar to as described above, one of skill in the art would appreciate that in some of the embodiments where there are collective auxiliary inputs 671, the one or more pre-processing operations described above for step 404 are also applied to the collective auxiliary inputs 671.

For the embodiments where collective auxiliary inputs 671 comprise a collective ethical input: In some of these embodiments the one or more pre-processing operations comprise a thresholding operation. For example, when the collective ethical input risk value is less than a threshold, then the thresholding operation outputs a zero (0). When the collective ethical input risk value is more than the threshold, then the thresholding operation outputs a one (1). In some embodiments, the threshold is zero (0). In some embodiments, the threshold is set to a value greater than zero to take into account the possibility of collective ethical risk measurement errors and noise.

Similar to as described above, for some of the embodiments where collective auxiliary inputs 671 comprise an ethical input: In some of these embodiments, the collective MRM operation 619 does not convert a collective ethical input or a pre-processed collective ethical input into a fuzzy variable. Rather it converts the collective ethical input or the pre-processed collective ethical input into one state or another, for example “low risk” or “high risk”.

In step 703, which is similar to step 406 in FIG. 4, the fuzzy logic controller 301 implements collective MRM operation 619 to execute all applicable rules to compute overall fuzzy risk management output functions using the risk management outputs 613, 615 and 617 as risk management inputs, the collective auxiliary inputs 671, and the rule base created in step 702. In some embodiments, this comprises using the output fuzzy states associated with risk management outputs 613, 615 and 617.

Steps 704 and 705 are similar to steps 407 and 408 of FIG. 4. In step 704, the fuzzy logic controller 301 implements collective MRM operation 619 to aggregate the computed overall fuzzy risk management output functions.

In step 705, the fuzzy logic controller 301 implements collective MRM operation 619 to assign an overall risk management output fuzzy state based on the output of the aggregation of rule consequent values. For example, the overall risk management output fuzzy states are drawn from the set {“Loss”, “Zero” and “Gain”} and then combined to assign an overall risk management output fuzzy state. Similar to as described before, for some of the embodiments where collective auxiliary inputs 671 comprise a collective ethical input which overrides all other inputs, the overall risk management output fuzzy state is sent to a state which reflects high risk. For example, in the set {“Loss”, “Zero” and “Gain”}, the overall risk management output fuzzy state is sent to the “Loss” state.

In step 706, defuzzification is performed. As would be known to one of skill in the art, defuzzification comprises producing a single numeric amount to represent an output. Examples of defuzzification techniques comprise the center of area or centroid method, the center of gravity method, the bisector method, and the weighted average method. Specifically, in step 706, this comprises extracting a single number from the overall risk management output fuzzy state assigned in step 705. In particular, the risk management output state is “defuzzified” into overall risk management output 621, which as explained previously, comprises, for example, a monetary amount or an amount of a measure related to a risk, for example, an operational, reputational, moral and ethical risk.

In step 707, based on either the defuzzification in step 706 or the assigned risk management output state in step 705, one or more actions are performed. In some embodiments, these one or more actions are performed by the collective MRM operation 619. In other embodiments, at least one of the fuzzy logic controller 301 and validation processing subsystems 230-1 to 230-N performs the one or more actions. Examples of the one or more actions have been described previously with respect to step 409 in FIG. 4.

In some embodiments, along with model risk aggregation, compliance aggregation is performed by fuzzy logic controller 301. Compliance aggregation functions take in a sequence of compliance statuses associated with risk management inputs and return a single compliance status that summarizes the overall compliance status with an AI policy.

An example is shown in FIG. 6B. In FIG. 6B, each of the risk management inputs 602, 606 and 610 from models 601, 605 and 609 respectively are directed to compliance aggregation function 6B-03. Each of these inputs have an associated compliance status, and the compliance statuses are received by compliance aggregation function 6B-03 implemented by fuzzy logic controller 301. Compliance aggregation function 6B-03 produces overall compliance status 6B-05 based on the inputted statuses.

The form of the compliance aggregation function 6B-03 depends on the specific context of the AI system and the desired compliance metric. Examples of various compliance aggregation functions include:
All-or-Nothing Compliance Function: Overall compliance status 6B-05 is compliant only when every risk management input has a compliant status.
Majority Vote Compliance Function: Overall compliance status 6B-05 is compliant when the majority of the compliance statuses are compliant, and not-compliant otherwise.
Weighted Majority Compliance Function: Overall compliance status 6B-05 is compliant when a weighted sum of the compliance statuses exceeds a certain threshold.
Maximum Compliance Function: Overall compliance status 6B-05 is compliant when the most stringent compliance status among the risk management inputs is compliant.
Minimum Compliance Function: Overall compliance status 6B-05 is compliant when the least stringent compliance status among the risk management inputs is compliant.
Mean Compliance Function: Overall compliance status 6B-05 is the average compliance status of the risk management inputs.
Median Compliance Function: Overall compliance status 6B-05 is the median compliance status of the risk management inputs.
Proportional Compliance Function: Overall compliance status 6B-05 is compliant when a certain proportion of the compliance statuses are compliant.
Upper Bound Compliance Function: Overall compliance status 6B-05 is compliant when the number of compliant risk management inputs is above a certain threshold.
Lower Bound Compliance Function: Overall compliance status 6B-05 is compliant when the number of compliant risk management inputs is below a certain threshold.

In some embodiments, compliance aggregation function 6B-03 is implemented as part of collective MRM operation 619 of FIG. 6A.

In some cases, the output from a first model in a plurality of models feeds into the input of a coupled second model in the plurality of models. This can lead to risk amplification.

Then, “sequential” MRM is performed, wherein a risk management output from the fuzzy logic MRM operation carried out for the first model, is used as a risk management input to the fuzzy logic MRM operation carried out for the second model.

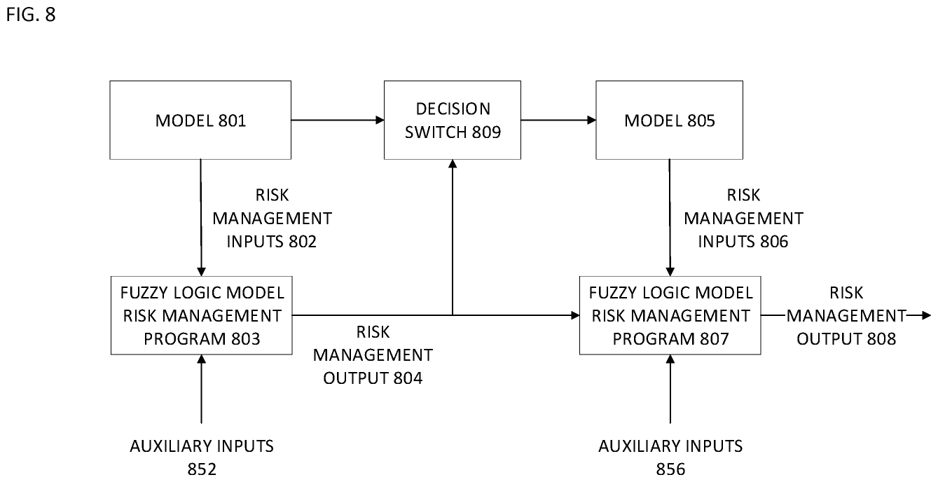

An example is shown in FIG. 8. In FIG. 8, fuzzy logic MRM program 803 receives risk management inputs associated with model 801, and produces risk management output 804. In some embodiments, fuzzy logic MRM program 803 receives auxiliary inputs 852 and uses it together with risk management inputs 802 to produce risk management output 804. The auxiliary inputs are similar to those described above. In some embodiments, the process outlined above with reference to FIGS. 4 and 5 is used by fuzzy logic MRM 803 to produce output 804. The model output from model 801 is fed as an input to coupled model 805. In some embodiments, the feed of the model output as an input is controlled by a decision switch 809 as will be explained below. In some embodiments, decision switch 809 is implemented in software. In other embodiments, decision switch 809 is implemented in hardware. In yet other embodiments, decision switch 809 is implemented using a combination of hardware and software. In some embodiments, decision switch 809 is controlled by one or more validation processing subsystems 230-1 to 230-N. In some of these embodiments, decision switch 809 is controlled by one or more fuzzy logic controllers such as fuzzy logic controller 301, as will be explained below.

Then, risk may be amplified in this situation, as failures in model 801 may cascade into model 805. To alleviate this, the fuzzy logic controller sends risk management output 804 as a risk management input to fuzzy logic MRM 807, along with risk management inputs 806 associated with model 805. Then, fuzzy logic MRM 807 produces risk management output 808 based on inputs 806 and output 804. In some embodiments, fuzzy logic MRM 807 also uses auxiliary inputs 856 to produce risk management output 808. These auxiliary inputs are similar to those described above. In some embodiments, the processes outlined above with reference to FIGS. 4 and 5 are used by fuzzy logic MRM 803 to produce output 808. In some of these embodiments, the step of creating of the rule base by fuzzy logic MRM 807, similar to step 402 of FIG. 4, utilizes the inputs associated with model 805, auxiliary inputs 856 and risk management output 804. Similar to as described before, the validation users 141 determines a weight for risk management output 804, so as to determine the influence of risk management output 804 on risk management output 808.

As described above, in some embodiments, one or more of auxiliary inputs 852 and 856 comprise one or more ethical inputs. Then, similar to as explained before, in some embodiments, the one or more ethical inputs dominate the production of one or more of the risk management outputs 804 and 808. In other embodiments, the one or more ethical inputs override the other inputs in the production of one or more of the risk management outputs 804 and 808. In these embodiments, the rule bases for one or more of the fuzzy logic MRM programs 803 and 807 include one or more rules to reflect this, as described before.

Fuzzy logic MRM programs 803 and 807 are implemented by one or more fuzzy logic controllers. In some embodiments, fuzzy logic MRM programs 803 and 807 are implemented by two different fuzzy logic controllers, each of which are similar to fuzzy logic controller 301. In other embodiments, the implementation is performed by the same fuzzy logic controller, for example, fuzzy logic controller 301.

In some embodiments, to avoid cascading failures, based on the output fuzzy state of risk management output 804, decision switch 809 is turned off. The turning off operation prevents the first model output from being input to the second model. The turning off operation can be performed in a variety of ways. In some of the embodiments where the same fuzzy logic controller, for example fuzzy logic controller 301, implements fuzzy logic MRM programs 803 and 807, the turning off operation is performed by at least one of fuzzy logic controller 301 and validation processing subsystem 230-1 to 230-N. In some of the embodiments where different fuzzy logic controllers implement fuzzy logic MRM programs 803 and 807, the turning off operation is performed by at least one of the fuzzy logic controllers which implement fuzzy logic risk management programs 803 and 807; and validation processing subsystem 230-1 to 230-N.

In other embodiments, based on risk management output 808, one or more risk management or risk mitigation actions are performed. Examples of the one or more actions have been previously described. The one or more risk management or risk mitigation actions can be performed in a variety of ways. In some of the embodiments where fuzzy logic controller 301 implements fuzzy logic MRM programs 803 and 807, the one or more risk management or risk mitigation actions are performed by at least one of fuzzy logic controller 301 and validation processing subsystem 230-1 to 230-N either within at least one of the fuzzy logic MRM programs 803 and 807, or outside of the fuzzy logic MRM programs. In other embodiments, the one or more risk management or risk mitigation actions are performed by at least one of the fuzzy logic controllers which implement fuzzy logic risk management programs 803 and 807 and validation processing subsystem 230-1 to 230-N.

One of skill in the art would appreciate that while an example embodiment of a system and method was demonstrated above for two coupled models, this system and method can be extended to a plurality of models having more than two coupled models. In some embodiments, the one or more validation processing subsystems comprises one or more fuzzy logic controllers to implement a fuzzy logic MRM program for each of the plurality of artificial intelligence or machine learning models. Then, each fuzzy logic MRM program for a first model is coupled to a fuzzy logic MRM program for each of the other models that the first model is coupled to, such that the risk management output from the first model is fed as an input to the fuzzy logic MRM program for each of the other models.

In yet further embodiments, model risk aggregation and sequential MRM approaches are combined.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

1. A system for performing model risk management (MRM) of an artificial intelligence or machine learning model comprising:
one or more validation processing subsystems comprising a fuzzy logic controller to implement a fuzzy logic MRM program associated with the artificial intelligence or machine learning model, and
one or more validation devices associated with one or more validation users communicatively coupled to the one or more validation processing subsystems;
a fuzzy logic controller, executing the fuzzy logic model risk management (MRM) program, being configured for:
receiving, from the one or more validation devices, metadata related to risk management inputs and a risk management output for the fuzzy logic MRM program;
generating a rule base using the received metadata;
receiving, from the one or more validation devices, the risk management inputs for the fuzzy logic MRM program;
applying one or more pre-processing operations on the risk management inputs;
fuzzifying the pre-processed risk management inputs to generate fuzzified risk management inputs;
executing one or more rules in the rule base using the fuzzified risk management inputs to calculate rule consequent values of the fuzzy logic MRM program;
aggregating the rule consequent values;
assigning a risk management output fuzzy state based on the aggregated rule consequent values; and
at least one of the fuzzy logic controller or the one or more validation processing subsystems being further configured for generating one or more output actions based on the assigning.

2. The system of claim 1, wherein the fuzzy logic controller is initially configured for prompting one or more validation users via the one or more validation devices, to provide metadata.

3. The system of claim 2, wherein the prompting of the one or more validation users is performed utilizing a user interface transmitted to the one or more validation devices.

4. The system of claim 1, wherein
each of the risk management inputs has a corresponding plurality of fuzzy states,
the metadata related to the risk management inputs and the risk management output comprises parameters related to the risk management inputs and parameters related to the risk management output, the parameters related to the risk management inputs comprising,
a name of each of the risk management inputs,
a number of the risk management inputs,
a number of fuzzy states corresponding to each risk management input,
a name of each of the plurality of fuzzy states corresponding to each of the risk management inputs,
a range corresponding to each of the risk management inputs,
an influence direction corresponding to each of the risk management inputs, and
an importance weight corresponding to each of the risk management inputs.

5. The system of claim 1, wherein generating the rule base comprises the fuzzy logic controller being further configured for:
calculating a number of rules based on the number of risk management inputs and the number of the plurality of fuzzy states corresponding to each of the risk management inputs,
generating a classification scheme for a space associated with the risk management output,
based on the classification scheme, determining a sub-region for each of a plurality of combinations of risk management input fuzzy states, wherein each of the plurality of combinations of risk management input fuzzy states comprises one of the plurality of fuzzy states corresponding to each of the inputs, and
based on the determining, populating the rule base with a plurality of rules, wherein each of the plurality of rules corresponds to one of the plurality of combinations of input fuzzy states.

6. The system of claim 1, wherein the one or more pre-processing operations comprises a normalization operation.

7. The system of claim 1, wherein the calculating of the one or more fuzzified values related to the output is performed using a Mamdani inference system or a Sugeno inference system.

8. The system of claim 1, further wherein the fuzzy logic controller, executing the fuzzy logic MRM program, is further configured for:
receiving metadata related to one or more auxiliary inputs from the one or more validation devices;
generating the rule base using the metadata related to the one or more auxiliary inputs;
receiving the one or more auxiliary inputs from one or more auxiliary sources; and
executing one or more rules in the rule base based on the received one or more auxiliary inputs.

9.-11. (canceled)

12. The system of claim 18, further wherein the fuzzy logic controller, executing the fuzzy logic MRM program, is configured for:
applying one or more pre-processing operations on the received one or more auxiliary inputs, wherein the one or more pre-processing operations comprise a thresholding operation.

13. The system of claim 1, wherein, wherein the one or more output actions comprises transmitting at least one of:
a notification or alert to the one or more validation devices;
a command to cause the artificial intelligence or machine learning model to go offline,
one or more prompts to one or more development devices coupled to the communications subsystem via the network to perform at least one of examining, replacing or rectifying the model,
one or more prompts and signals to update at least one of inventory and dashboards, and
one or more prompts and signals to at least one: (i) integrated internal subsystem, (ii) compliance subsystem, and (iii) risk management subsystem, communicatively coupled to the fuzzy logic controller.

14. A method for performing model risk management (MRM) of an artificial learning or machine learning model comprising:
receiving, from one or more validation devices, metadata related to risk management inputs and risk management output;
generating a rule base related to the received metadata;
receiving, the risk management inputs from the one or more validation devices;
applying, one or more pre-processing operations on the received risk management inputs;
fuzzifying, the pre-processed risk management inputs to generate fuzzified risk management inputs;
executing, one or more rules in the rule base using the fuzzified risk management inputs to calculate rule consequent values;
aggregating, the rule consequent values;
assigning, a risk management output fuzzy state based on the aggregated rule consequent values; and
generating one or more output actions based on the assigning.

15. The method of claim 14, initially comprising prompting one or more validation users via one or more validation devices to provide metadata.

16. The method of claim 14, wherein the risk management inputs are based on at least one of:
financial performance measures associated with the artificial intelligence or machine learning model;
statistical risk measures associated with the artificial intelligence or machine learning model;
relative performance of the artificial intelligence or machine learning model compared to a benchmark model;
one or more statistical accuracy measures related to the artificial intelligence or machine learning model;
sign accuracy associated with the artificial intelligence or machine learning model;
one or more costs associated with the artificial intelligence or machine learning model;
economic value associated with the artificial intelligence or machine learning model; and
one or more measures of fairness or bias associated with the artificial intelligence or machine learning model.

17. The method of claim 14, wherein one of the risk management inputs is either qualitative or quantitative.

18. The method of claim 15, wherein the prompting of the one or more validation users comprises transmitting a user interface to the one or more validation devices.

19. The method of claim 14, wherein
each of the risk management inputs has a corresponding plurality of fuzzy states,
the metadata related to the risk management inputs and the risk management output comprises parameters related to the risk management inputs and parameters related to the risk management output, the parameters related to the risk management inputs comprise one or more of,
a name of each of the risk management inputs,
a number of the risk management inputs,
a number of fuzzy states corresponding to each risk management input,
a name of each of the plurality of fuzzy states corresponding to each of the risk management inputs,
a range corresponding to each of the risk management inputs,
an influence direction corresponding to each of the risk management inputs, and
an importance weight corresponding to each of the risk management inputs.

20. The method of claim 14, wherein the creating of the rule base comprises:
calculating a number of rules based on the number of risk management inputs and the number of the plurality of fuzzy states corresponding to each of the risk management inputs,
generating a classification scheme for a space associated with the risk management output,
based on the classification scheme, determining a sub-region for each of a plurality of combinations of risk management input fuzzy states, wherein each of the plurality of combinations of risk management input fuzzy states comprises one of the plurality of fuzzy states corresponding to each of the inputs, and
based on the determining, populating the rule base with a plurality of rules, wherein each of the plurality of rules corresponds to one of the plurality of combinations of input fuzzy states.

21. The method of claim 14, further comprising:
receiving, metadata related to one or more auxiliary inputs from the one or more validation devices;
performing, the generating of the rule base using the metadata related to the one or more auxiliary inputs;
receiving, the one or more auxiliary inputs from one or more auxiliary sources; and
executing, one or more rules in the rule base based on the received one or more auxiliary inputs.

22.-24. (canceled)

25. The method of claim 21, further wherein the fuzzy logic MRM program:
performs one or more pre-processing operations on the received one or more auxiliary inputs, wherein the one or more pre-processing operations comprise a thresholding operation.

26. The method of claim 14, wherein the one or more actions comprise transmitting at least one of:
a notification or alert to the one or more validation devices,
a command to cause the artificial intelligence or machine learning model to go offline,
one or more prompts to one or more development devices coupled to the communications subsystem via the network to perform at least one of examining, replacing or rectifying the model,
one or more prompts and signals to update at least one of inventory and dashboards, and
one or more prompts and signals to at least one: (i) integrated internal subsystem, (ii) compliance subsystem, and (iii) risk management subsystem.

27.-60. (canceled)
